(19) United States
(12) Patent Application Publication
(10) Pub. No.: US 2010/0182420 A1
(43) Pub. Date: Jul. 22, 2010

(54) Image Acquisition System for Identifying Signs on Mailpieces

(75) Inventors: Claude Mitte, Montigny Les Cormeilles (FR); Celine Guignard, Issy Les Moulineaux (FR)

Correspondence Address: ROTHWELL, FIGG, ERNST & MANBECK, P.C., 1425 K STREET, N.W., SUITE 800, WASHINGTON, DC, 20005, US

(73) Assignee: SOLYSTIC, Gentilly Cedex (FR)

(21) Appl. No.: 12/442,545

(22) PCT Filed: Jan. 26, 2009
(86) PCT No.: PCT/FR09/50107

§ 371 Date: Mar. 24, 2009

(30) Foreign Application Priority Data
Feb. 1, 2008 (FR) 0850640

(51) Int. Cl. H04N 7/18

(52) U.S. Cl. 348/86; 348/E07.085

(57) ABSTRACT

An image acquisition system for identifying signs on mailpieces wherein each mailpiece is moved by being nipped between a conveyor and a housing wall that is provided with a longitudinal slot, comprises, inside the housing, an illumination module having two lighting units that are symmetrical about the slot for the purpose of illuminating a surface defined by the slot, and a camera for forming an image of said illuminated surface, polarization optical means also being disposed between said illumination module and said illuminated surface, and a polarization optical filter being disposed between said camera and said surface. The slot is closed by a flush transparent rigid wall against which each mailpiece is pressed.

### CROSS-REFERENCE TO RELATED APPLICATIONS

This application is a 35 U.S.C. 371 National Phase Application from PCT/FR2009/050107, filed Jan. 26, 2009, and designating the United States, which claims the benefit of France Patent Application No. 0850640, filed Feb. 1, 2008.

### BACKGROUND OF THE INVENTION

1. Field of the Invention

The invention relates to an image acquisition system for identifying signs on mailpieces that are in motion.

The invention relates more particularly to an image acquisition system in a postal sorting machine for implementing a technique for identifying mailpieces by image signature that is known under the trademark “V_Id”™ and is described by Patent Document EP 1 519 796 to SOLYSTIC.

2. Discussion of the Background Art

An image acquisition system for a postal sorting machine is known from Document US 2001/0019619. In such a system, each mailpiece is moved by being nipped between a conveyor and a housing wall in which a longitudinal slot is formed so that the signs to be identified that are placed on a face of the mailpiece are caused to appear in the slot. Inside the housing, the system includes an illumination module having two lighting units that are symmetrical about the slot and that illuminate the observation surface defined by the slot, and a camera disposed so as to form an image of said illuminated surface.

French Patent Document FR 2 895 820 also discloses an image acquisition system as defined above for recognizing address information on mailpieces. With that system, it has been observed that, for mailpieces in covers made of plastics material, successive images taken for the same mailpiece, e.g. during the first sorting pass, and then during the second sorting pass, can present differences so that it is not possible to implement an identification technique based on image signatures. The structure differences in the successive images are due, in particular, to a phenomenon of mirror reflection whereby the light beams are reflected off the plastics material surfaces of the mailpieces.

Patent Document WO 2007/022 985 also discloses an image acquisition system in which the illumination module is a strip of light-emitting diodes (LEDs) or the like disposed on a single longitudinal side of the slot so as to illuminate the surface defined by the slot with a certain angle of incidence directed in the direction in which the successive mailpieces go past the slot outside the housing. In addition, crossed polarization filters (i.e. optical filters that have respective axes perpendicular to each other) are disposed firstly between the LED strip and the illuminated surface defined by the slot, and secondly between the camera and said illuminated surface, in order to eliminate the effects of said mirror reflection phenomenon. But in that acquisition system, it has been observed that such slanting illumination emphasizes the surface irregularities of certain mailpieces by causing shadows to appear on the illuminated surfaces of the mailpieces, in particular for mailpieces having covers that are made of relatively soft paper or that have minor defects (such as creases, bumps, folded-over portions or flaps, heat-seal strips on plastics material covers, etc.). As a result, low-frequency noise is introduced into the successive images of the mailpieces. With that image acquisition system, it is thus not possible to obtain images of various mailpieces in reproducible manner and with image quality that is sufficient to use an image-signature identification technique. In the V_Id™ technique, it is possible to identify a mailpiece unambiguously during the successive sorting passes of the sorting process, without printing any codes on the surface of the mailpiece. More particularly, during a first sorting pass, the image of each mailpiece is taken by a camera, and attributes extracted from said image serve to construct an image signature for said mailpiece. Said signature is recorded in a memory in correspondence with sorting information extracted conventionally by Optical Character Recognition (OCR) processing and/or by video-coding processing. During a second sorting pass, a new current image of the mailpiece is taken by the camera and attributes are extracted from said current image in order to construct a current image signature for the mailpiece. The current signature is compared with the signatures recorded in the memory and, if the current signature matches a signature in the memory, sorting information is retrieved for the mailpiece. For this identification technique, it is essential for the successive images that are taken of the same mailpiece to be substantially identical. It can be understood that if the same image signature construction processing is applied to two different images, there is a high probability that two different results will be obtained, even if the two images correspond to the same mailpiece.

### SUMMARY OF THE INVENTION

An object of the invention is to provide an image acquisition system that is adapted to a postal sorting machine, that does not suffer from the above-indicated drawbacks, and that is suitable for delivering images for mailpieces having covers made of plastics materials or of paper and with image quality that is sufficient for implementing a technique for identifying the mailpieces by image signature.

To this end, the invention provides an image acquisition system for identifying signs on mailpieces wherein each mailpiece is moved by being nipped between a conveyor and a housing wall in which a longitudinal slot is formed in a manner such that the signs to be identified that are placed on a face of the mailpiece are caused to appear in the slot, the system comprising, inside the housing, an illumination module having two lighting units that are substantially identical, that are disposed symmetrically on either side of the slot, and that illuminate a surface defined by the slot, and a camera disposed to form an image of said illuminated surface, polarization optical means also being disposed between said illumination module and said illuminated surface, and a polarization optical filter being disposed between said camera and said illuminated surface, said image acquisition system being characterized in that said slot is closed by a flush transparent rigid wall against which each mailpiece is pressed.

In this arrangement, the transparent rigid wall that closes the observation slot is flush relative to the housing wall against which the mailpiece is nipped flat, thereby preventing the surface of the mailpiece from deforming as said mailpiece moves over the slot. This arrangement contributes to reproducibly taking successive images of the same mailpiece that are identical regardless of whether said mailpiece has a cover made of a plastics material or a cover made of paper, and independently of the surface irregularities of the mailpieces (surfaces that are plane, smooth, with portions in relief or with creases, damaged, etc.).

According to the invention, each lighting unit is directed towards said illuminated surface in a respective illumination incidence direction at an angle of incidence lying in the range 10° to 60° approximately, and a respective distance between each lighting unit and said illuminated surface in the illumination incidence direction that lies in the range 5 millimeters (mm) to 50 mm approximately.

With such values for the angles of incidence of the lighting units and for the distances between each lighting unit and said illuminated surface, it is possible to obtain optimum symmetrical illumination that eliminates the shadow phenomenon, thereby making it possible to take images of the surfaces of the mailpieces that are of good quality.

The image acquisition system of the invention may also have the following features:
each lighting unit comprises at least one strip of LEDs referred to as “Surface Mount Components” (“SMCs”) that emit white light;
the pitch of consecutive LEDs on a strip lies in the range the width of such an LED to 40 mm;
the slot is of a width that lies in the range 10 mm to 24 mm approximately;
said transparent rigid wall is made of sapphire;
the polarization optical means comprise first and second polarization optical filters; the first polarization optical filter is disposed between the first lighting unit and the illuminated surface, and the second polarization optical filter is disposed between the second lighting unit and the illuminated surface, respective polarization axes of the first and second polarization optical filters being respectively perpendicular to a polarization axis of the polarization optical filter disposed between the camera and said illuminated surface;
an optical axis of said camera is substantially perpendicular to the transparent rigid wall;
there are provided two ventilation columns disposed on either side of the illumination module;
the camera is a multiple-level gray scale first camera, and the image acquisition system of the invention further comprises a color second camera disposed with an optical axis perpendicular to an optical axis of the first camera, and a mirror is disposed in such a manner as to enable images of said illuminated surface to be acquired simultaneously by the two cameras; and
the illumination module further comprises two other lighting units disposed symmetrically on either side of the slot and in a manner such as to illuminate a central strip of said surface corresponding to an acquisition zone of the less sensitive one of the first and second cameras.

The invention also provides a postal sorting machine including an image acquisition system of the invention, which image acquisition system further comprises a conveyor device for conveying the mailpieces past said slot and elastically deformable wheels that are mounted on either side of the slot for the purpose of pressing the mailpieces against the transparent rigid wall.

### BRIEF DESCRIPTION OF THE DRAWINGS

The image acquisition system is described in more detail below and is shown in the drawings. This description is given merely by way of indication and is in no way limiting on the invention. In the drawings:

FIG. 1 is a fragmentary perspective view of the image acquisition system of the invention included in a section of a postal sorting machine;

FIG. 2 is a perspective view of the image acquisition system of the invention of FIG. 1, seen from the opposite side;

FIG. 3 is a perspective view of the housing of the image acquisition system of the invention;

FIG. 4 is a highly diagrammatic view from above and in section, showing the image acquisition system of the invention;

FIG. 5 is a highly diagrammatic view from above and in section, showing a particular embodiment of the image acquisition system of the invention; and

FIG. 6 is a highly diagrammatic view from above and in section, showing another particular embodiment of the image acquisition system of the invention.

### DETAILED DESCRIPTION OF THE PREFERRED EMBODIMENTS

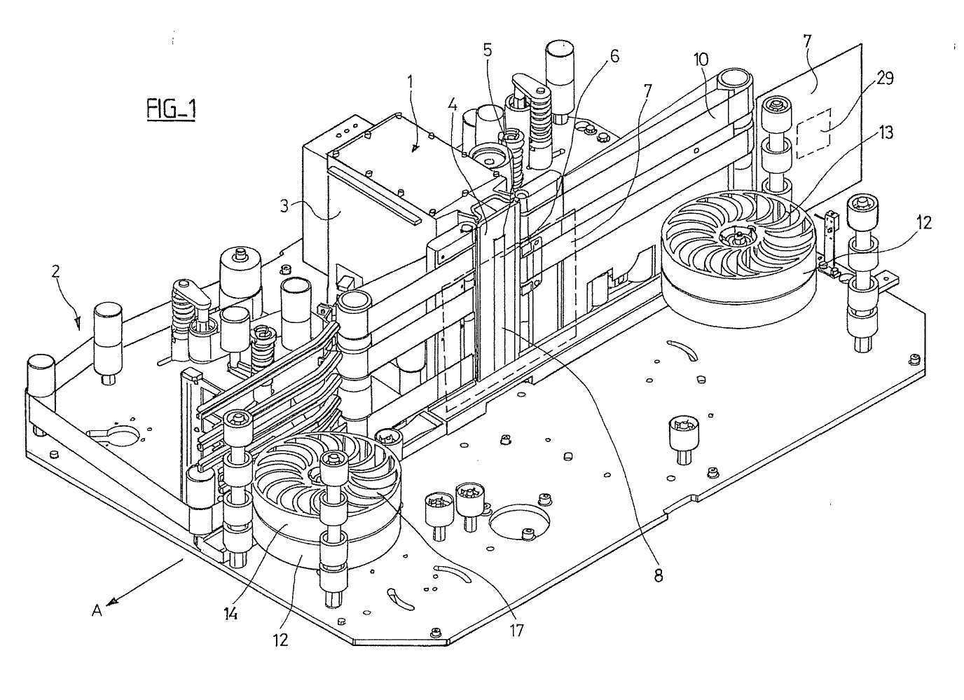

FIG. 1 shows an image acquisition system 1 of the invention that is incorporated into a section 2 of a postal sorting machine. For reasons of clarity, certain elements of the postal machine section 2 are not shown so as to allow the image acquisition system 1 to appear more clearly.

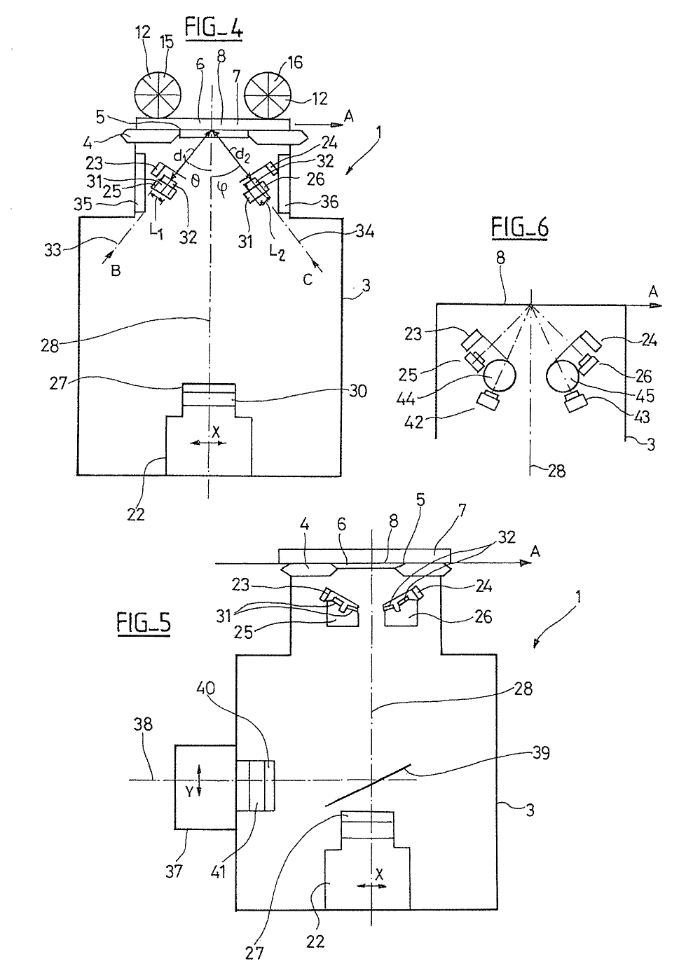

The image acquisition system 1 includes a housing 3 that has a wall 4 provided with a slot 5 that is closed by a rigid and transparent wall 6 past which mailpieces 7 are conveyed on edge, in a conveying direction indicated by arrow A, and in such a manner as to present to the image acquisition system 1 a surface to be illuminated. More precisely, an illumination module (described below with reference to FIG. 4) makes it possible, through the rigid and transparent wall 6, to illuminate a surface 8 defined by the slot 5 and corresponding to a portion of the surface of the mailpiece 7. It can be understood that the surface 8 corresponds to the outside surface of the rigid and transparent wall 6 relative to the housing 3. The height of the slot 5 is chosen in such a manner that the entire height of each of the mailpieces 7 is illuminated. Thus, when the mailpiece 7 is conveyed past the slot 5, images of the entire surface of the mailpiece 7 are progressively acquired. On the surface of the mailpiece 7, signs 29 to be identified are shown, which signs are, for example, constituted by the destination address of the mailpiece or by a bar code in contrast, and serve for automatic sorting of the mailpieces 7.

The rigid and transparent wall 6 is preferably made of a material having the characteristics both of high optical transmission and of high resistance to abrasion, such a material being, for example, sapphire. Conventional glass is damaged by the mailpieces 7 going past at high speed against the rigid and transparent wall 6, and such glass needs to be changed after about 1,200,000 mailpieces have gone past. Conversely, the high resistance to abrasion of sapphire makes it possible to use the same rigid and transparent wall 6 for the entire life of the image acquisition system 1. In addition, the presence of polarization filters, as described below with reference to FIGS. 4 to 6, makes it possible to be unaffected by small fluctuations in polarization of the radiation that can be observed at the outlet of a rigid and transparent wall 6 made of sapphire.

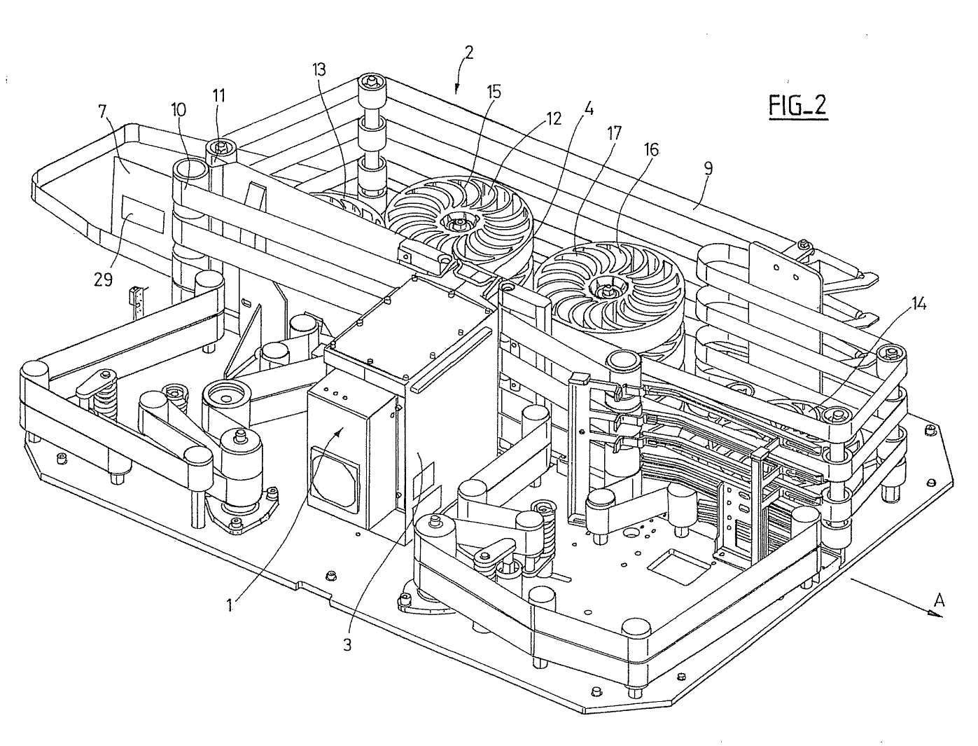

FIG. 2 shows the FIG. 1 section of a postal sorting machine 2 seen looking from the opposite side. The postal sorting machine section 2 includes a belt conveyor device 9 that nips the mailpieces 7 between two mutually opposite belts 10, 11 so as to convey them in the conveying direction A. A pressing device 12 made up of four wheels 13, 14, 15, 16 having crescent-shaped spokes 17 made of an elastically deformable plastics material and whose respective spindles are stationary, presses the mailpieces 7 in a direction perpendicular to the conveying direction A. The four wheels 13, 14, 15, 16 are mounted such that they are spaced apart from one another in the conveying direction A, on either side of the slot 5 formed in the wall 4 of the housing 3.

In a particular embodiment, two wheels 15, 16 of the pressing device 12 are positioned such that they are spaced apart by a distance less than the size of a mailpiece 7 in the direction indicated by arrow A, so as to press the mailpiece 7 against the rigid and transparent wall 6. The mailpiece 7 pressed against said wall in this way finds itself substantially parallel to the rigid and transparent wall 6. Thus, the rigid and transparent wall 6 limits deformation of the mailpiece 7 while said mailpiece is passing through the postal sorting machine section 2, in particular when the mailpieces are soft paper mailpieces, thereby enabling the images of the mailpiece 7 that are acquired by the acquisition system 1 to be flawless and reproducible.

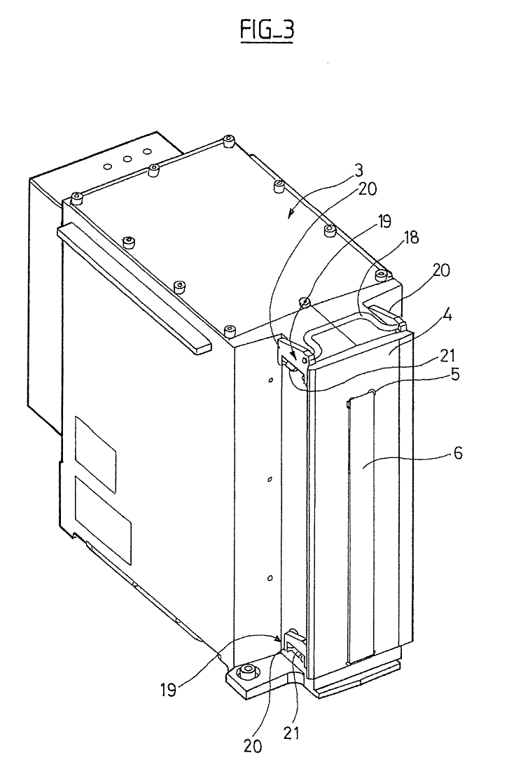

FIG. 3 shows the housing 3 that is substantially rectangular block shaped, with the wall 4 provided with the slot 5. More particularly, the wall 4 comprises a removable wall provided with a handle 18 making it possible to remove the wall 4 by pulling it upwards, and with four locking devices 19 disposed respectively at the top and at the bottom and on either side of the removable wall 4. Each locking device 19 comprises a hook 20 pivotally secured to the removable wall 4, and designed to lock onto a lug 21 that is secured to the housing 3.

FIG. 4 diagrammatically shows the image acquisition system 1 including, inside the housing 3, an illumination module made up of two lighting units 25, 26 disposed to illuminate the surface 8 defined by the slot 5 at a certain slanting angle of incidence, and a camera 22 disposed in the housing 3 so as to form an image of said surface 8.

The two lighting units 25, 26 are disposed symmetrically on either side of the slot 5 and at some distance from the surface 8, as defined below, thereby delivering symmetrical illumination of the surface 8. In addition, the two lighting units 25, 26 are substantially identical, as explained in detail below, thereby guaranteeing illumination that is distributed uniformly over the entire surface 8, and thereby making it possible to reduce or even to eliminate shadows formed by slanting illumination on soft mailpieces 7, in particular made of paper, or mailpieces having surface defects such as creases.

In a particular embodiment, the camera 22 is disposed in a manner such that an optical axis 28 thereof substantially coincides with a normal to the rigid and transparent wall 6 and to the illuminated surface 8. This guarantees that the entire surface 8 is the same distance away from the camera 22, thereby avoiding deformation of the images taken by the camera 22, and facilitating subsequent processing of said images. In addition, the slot 5 is preferably centered on the optical axis 28 and the two lighting units 25, 26 thus find themselves disposed symmetrically about the optical axis 28 of the camera 22.

The images acquired by the first camera 22 are transmitted to an image processing device (not shown) and are then processed by it in a manner that is conventional for decoding the signs 29. For example, the image processing can be effected by OCR for mailpiece sorting.

FIG. 4 shows first polarization optical means made up of first and second polarization optical filters 23, 24 that deliver linearly polarized light and that are disposed between respective ones of the lighting units 25, 26 and the illuminated surface 8. A third linear polarization optical filter 27 is disposed between the camera 22 and the illuminated surface 8. The respective polarization axes of the first and second polarization optical filters 23, 24 are perpendicular to the polarization axis of the polarization filter 27 that is disposed between the camera 22 and said illuminated surface 8, i.e. the polarization axes cross at an angle of about 90°, thereby making it possible to reduce or even to eliminate the phenomenon of mirror reflection on plastics material surfaces. The third polarization filter 27 is advantageously fastened to a ring (not shown) making it possible for the polarization axis of said third polarization filter 27 to be adjusted in rotation, in order to make it easy to reach a position in which the polarization filters 23, 24 are crossed relative to the polarization filter 27.

Additional optical elements 30, e.g. lenses, can be added in front of the camera 22, and preferably between the third polarization filter 27 and the camera 22 as shown in FIG. 4, in order to improve the quality of the image acquired by the acquisition system 1.

In a particular embodiment, each lighting unit 25, 26 comprises at least one strip 31 comprising a plurality of LEDs 32. The strips 31 are advantageously arranged longitudinally in the direction of the slot 5 (i.e. perpendicular to the plane of FIG. 4).

Computations and tests have made it possible to find an optimum position for each lighting unit 25, 26 relative to the surface 8 so as to obtain maximum illumination of the surface 8 that makes it possible to obtain images of quality sufficient for using an identification technique based on image signature, as a function of geometrical characteristics of the lighting units 25, 26 and of the camera 22, such as the widths of their respective acquisition zones.

More precisely, it is possible to compute a geometrical relationship between an angle of incidence θ formed by a first optical axis 33 defining a first illumination incidence direction B of the first lighting unit 25 relative to the optical axis 28 of the camera 22, and a distance d₁ between the lighting unit 25 and the surface 8 along the optical axis 33 or in the first illumination incidence direction B, as indicated in the FIG. 4. The distance d₁ should be understood as being the distance, in the first illumination incidence direction B, between the middle of the width of the lighting unit 25 (which middle corresponds to the center of an LED) and the intersection between the optical axis 28 and the surface 8, as measured at the same height on the lighting unit 25 and on the surface 8.

Similarly, it is possible to compute an identical relationship between an angle of incidence φ formed by a second optical axis 34 defining a second illumination incidence direction C of the second lighting unit 26 relative to the optical axis 28 of the camera 22, and a distance d₂ between the lighting unit 26 and the surface 8 along the optical axis 34 or in the second illumination incidence direction C, so that the two lighting units 25, 26 are disposed symmetrically about the optical axis 28 of the camera 22. The distance d₂ should also be understood as being the distance in the second illumination incidence direction C between the middle of the width of the lighting unit 26 and the intersection between the optical axis 28 and the surface 8, as measured at the same height on the lighting unit 26 and on the surface 8.

It has been found that maximum illumination of the surface 8 is obtained for angles θ and φ that are substantially identical and equal to 54.7°, and a distance d_{1,2} defined by the following relationship:

$${d}_{1 , 2} = \sqrt{\frac{3}{8}} ( X + {l}_{1 , 2} ) ,$$

where l_{1,2} is the respective width of each lighting unit 25, 26 (i.e. approximately the width of each strip 31), and X is the width of the acquisition zone of the first camera 22.

In practice, an optimum illumination position, representing about 90% of the above maximum illumination and satisfactory for obtaining images of good quality, is obtained when both of the conditions a) and b) below are satisfied:

a) the angle θ and the angle φ as defined above are substantially equal and lie in the range 40° to 55°.

b) the distances d_{1,2} as defined above are substantially obtained by the following relationships:

$${d}_{1} = \frac{X + {l}_{1} }{2 sin θ} , \\ {d}_{2} = \frac{X + {l}_{2}}{2 sin ϕ}$$

The camera 22 can be a multiple-level gray scale camera, e.g. a Time Delay Integration (TDI) multiple-level gray scale sensor having 64 rows, and having a resolution of 8 pixels per millimeter (px/mm) and that requires an acquisition zone X of width 8 mm or lying in the range 8 mm to 10 mm. It is also possible to choose a color camera, e.g. a “Piranha Color” camera sold under the Dalsa trademark, with a resolution lying, for example, in the range 2 px/mm to 8 px/mm, and requiring an acquisition zone lying, in general, in the range 1 mm to 5 mm approximately. In general, each of the LEDs of each lighting unit 25, 26 has a width of at least 5 mm, and each strip 31 has a width l_{1,2} of approximately 8 mm. For these values of the acquisition zone X and of the width l_{1,2}, the respective distance d_{1,2} between each lighting unit 25, 26 and the surface 8 then lies in the range 5 mm to 11 mm approximately when the angles θ and y are substantially identical and equal to 54.7°. When the angles θ and φ lie in the above-mentioned range of 40° to 55°, the distance d_{1,2} lies in the range 5 mm to 14 mm approximately (approximately 9 mm to 14 mm for a multiple-level gray scale camera of the type described above, and in the range 5 mm to 11 mm approximately for a color camera of the type described above).

Preferably, the slot 5 has a width chosen as a function of the resolution of the camera 22 and of the illumination module 25, 26. With a camera 22 of the TDI type as defined above, and with an illumination module 25, 26 as described above, an appropriate width lies in the range 10 mm to 24 mm for delivering, in particular, an illumination intensity that is satisfactory and that makes it possible to form quality images of the surface 8.

In practice, however, for reasons of mechanical compactness, it can happen that both of the conditions a) and b) might fail to be satisfied, in particular when each of the lighting units 25, 26 includes a plurality of strips 31 of LEDS 32 (as shown in FIG. 5). Satisfactory illumination of said surface 8 can be obtained in this situation by choosing angles θ and φ for each strip 31 lying in the range 10° to 60° approximately, and preferably in the range 25° to 55° approximately. The distances d_{1,2} are then modulated relative to the angles θ and φ so as to optimize the illumination of the surface 8, i.e. d_{1,2} lies in the range 5 mm to 50 mm approximately, and preferably in the range 5 mm to 22 mm approximately.

The LEDs 32 are advantageously chosen from among Surface Mount Components (SMCs) emitting white light, thereby making it possible to increase the illumination power relative to conventional LEDs. The strips 31 of LEDs 32 are substantially identical to one another in that they comprise LEDs 32 that are substantially identical, and each of them has the same number of LEDs, with the LEDs at the same pitch, etc.

In particular, on each of the strips 31, the LEDs 32 are spaced apart such that their illuminations overlap on said illuminated surface 8, thereby obtaining uniform illumination over the entire surface 8, in particular over the entire height of the surface 8 in the direction of the slot 5.

Tests have shown that the optimum pitch (e) as measured between the respective centers of two consecutive LEDs 32 on a strip 31 can be evaluated as a function of characteristics of the illumination, namely, the distance d_{1,2} as defined above, the emission angle α of an LED, the width L of an LED, and the overlap distance dₘᵢₙ of the radiation of the LEDs 32 on the surface 8, using the following relationship:

$$e = 2 ( {d}_{1 , 2} - {d}_{m i n} ) tan ( \frac{α}{2} ) where e > l .$$

Thus, for example, the optimum pitch e for LEDs 32 having a width of 5 mm is found to lie in the range 5 mm to 7 mm approximately, for a distance d_{1,2} lying in the range 9 mm to 14 mm, a distance dₘᵢₙ lying in the range 2 mm to 7 mm approximately, and LEDs 32 having an emission angle α of about 30°. Naturally, other values, in particular for the emission angle α of the LEDs 32, can be used without going beyond the scope of the invention. For example, for LEDs having an emission angle α of about 120° and the above conditions for d_{1,2} and dₘᵢₙ, the optimum pitch e for the LEDs 32 lies in the range 7 mm to 40 mm approximately. In general, the optimum pitch e for the LEDs 32 lies in the range L to 40 mm approximately, where L is the width of such an LED.

The optimum number of LEDs 32 necessary for fully illuminating the surface 8 is adjusted as a function of the height of the slot 5. Thus, LEDs 32 having an emission angle α that is wider, such as, for example 70°, 110°, or 120°, can be used, thereby making it possible to reduce the number of LEDs 32 necessary for illuminating the entire surface 8. It can be understood that each LED is disposed on a strip 31 in a manner such that the emitting surface of the LED is parallel to the strip 31 and in such a manner as to be directed towards the surface 8.

In general, the optical properties of the polarization filters 23, 27, 24 cannot be guaranteed for temperatures greater than 90° C. An extraction ventilation system comprising two ventilation columns 35, 36 can thus be disposed in the housing 3 as can be seen in FIG. 4, in order to avoid any instability due to heating of the polarization filters 23, 27, 24. The housing 3 as closed by the rigid and transparent wall 6 makes it possible to generate pressure that facilitates putting the extraction ventilation system into place. More particularly, as can be seen in FIG. 4, the ventilation columns 35, 36 are positioned respectively next to the first lighting unit 25 and next to the second lighting unit 26, thereby guaranteeing uniform extraction of heat over the entire illumination height. Heat extraction ventilation is advantageous because it does not cause any dust to enter the image acquisition system 1.

FIG. 5 shows a particular embodiment in which the acquisition system 1 further includes a second camera 37 disposed in a manner such as to take at least one image of the illuminated surface 8. Two strips 31 of LEDs 32 are shown on each lighting unit 25, 26. For example, the first camera 22 can be a multiple-level gray scale camera, and the second camera 37 can be a color camera. Advantageously, in accordance with the invention, a second camera can be provided for certain particular uses of the sorting machine section 2, e.g. for simultaneously performing different processing on images taken by the acquisition system 1. It is thus possible to satisfy both the need for good-quality multiple-level gray scale images of mailpieces for using the identification technique based on image signature, and also the need for color images for processing by video coding.

An optical axis 38 of the second camera 37 is substantially perpendicular to the optical axis 28 of the first camera 22 over a fraction of the path of the radiation between the surface 8 and the cameras 22, 37. A mirror 39 is disposed in such a manner as to make it possible for both cameras 22 and 37 to acquire images simultaneously of the illuminated surface 8. The mirror 39 can be a semi-reflective beam-splitter mirror disposed between the illuminated surface 8 and the first camera 22 so as to pass a first fraction of the radiation emitted by the lighting units 25, 26 and reflected by the surface 8 towards the first camera 22, and so as to deflect a second fraction of said radiation towards the second camera 37, in conventional manner, thereby enabling the two cameras 22, 37 to take images of the same mailpiece 7 simultaneously.

In a particular embodiment, the first camera 22 is a TDI multiple-level gray scale sensor having 64 rows and resolution of 8 px/mm, with an acquisition zone X of width 10 mm, while the color second camera 37 is a linear sensor having resolution of 1 px/mm and that requires an acquisition zone Y of width 2 mm. A fourth polarization optical filter 40 is disposed between the second camera 37 and the surface 8 in a manner such that a polarization axis of the fourth polarization filter 40 is crossed (perpendicular to) relative to the polarization axes of the first and second polarization filters 23, 24, the effect of which is to reduce the mirror reflection effect of surfaces, in particular surfaces made of plastics material. Other additional optical elements 41 can be added in front of the second camera 37, and preferably between the polarization filter 40 and the camera 37, as indicated in FIG. 5, so as to improve further the quality of the image acquired by the acquisition system 1.

FIG. 6 shows another particular embodiment of the invention including third and fourth lighting units 42, 43 that are preferably substantially mutually identical and that are disposed in such a manner as to illuminate the surface 8. The third and fourth lighting units 42, 43 are positioned on either side of the slot 5 and in such a manner as to direct their illumination onto the surface 8 through the first and second polarization optical filters 23, 24. One strip 31 of LEDs 32 is shown for each lighting unit 25, 26, 42, 43. Each lighting unit 42, 43 could also be made up of a plurality of strips 31 of LEDs 32 (not shown) similarly to the above-described lighting units 25, 26.

The third and fourth lighting units 42, 43 make it possible to improve the illumination on the surface 8, in particular by distributing the illumination over the surface 8 in the direction indicated by arrow A as a function of the different sensitivities of the cameras 22, 37. For example, it is possible to increase the intensity of illumination over a central strip of the illuminated surface 8 corresponding to the acquisition zone X,Y of the less sensitive camera that also has a narrow acquisition zone. In the example described above, for example, the color camera 37 is less sensitive than the multiple-level gray scale camera 22. Two optical elements 44, 45 such as, for example, lenses, can be positioned respectively between the third and the forth lighting units 42, 43, and preferably between the lighting units 42, 43 and the respective polarization filters 23, 24, as indicated in FIG. 6, so as to focus the radiation of the lighting units 42, 43 onto a central strip of the surface 8. Thus, even though the two cameras 22, 37 do not have the same sensitivity, they can nevertheless simultaneously take images of quality sufficient to make it possible for an identification technique based on image signature to be used subsequently.

1. An image acquisition system for identifying signs on mailpieces wherein each mailpiece is moved by being nipped between a conveyor and a wall of a housing in which wall a longitudinal slot is formed in a manner such that the signs to be identified that are placed on a face of the mailpiece are caused to appear in the slot in the wall of the housing, the system comprising, inside the housing, an illumination module having two lighting units that are substantially identical, that are disposed symmetrically on either side of the slot, and that illuminate a surface defined by the slot, and a camera disposed to form an image of said illuminated surface, polarization optical means also being disposed between said illumination module and said illuminated surface, and a polarization optical filter being disposed between said camera and said illuminated surface and a transparent rigid wall extending across said slot to form a flush surface against which each mailpiece is pressed.

2. An image acquisition system according to claim 1, wherein each lighting unit is directed towards said illuminated surface in a respective illumination incidence direction with an angle of incidence lying in the range of about 10° to about 60°, and a respective distance between each lighting unit and said illuminated surface in the illumination incidence direction that lies in the range of about 5 mm to about 50 mm.

3. An image acquisition system according to claim 1, wherein each lighting unit comprises at least one strip of LEDs that emit white light.

4. An image acquisition system according to claim 3, wherein the pitch of consecutive LEDs on a strip lies in the range of about the width of such an LED to about 40 mm.

5. An image acquisition system according to claim 1, wherein the slot is of a width that lies in the range of about 10 mm to about 24 mm.

6. An image acquisition system according to claim 1, wherein said transparent rigid wall is made of sapphire.

7. An image acquisition system according to claim 1, wherein the polarization optical means comprise first and second polarization optical filters, the first polarization optical filter being disposed between the first lighting unit and the illuminated surface, and the second polarization optical filter being disposed between the second lighting unit and the illuminated surface, respective polarization axes of the first and second polarization optical filters being perpendicular to a polarization axis of the polarization optical filter disposed between the camera and said illuminated surface.

8. An image acquisition system according to claim 1, wherein an optical axis of said camera is substantially perpendicular to the transparent rigid wall.

9. An image acquisition system according to claim 1, further comprising two ventilation columns disposed on either side of the illumination module.

10. An image acquisition system according to claim 1, wherein the camera is a multiple-level gray scale first camera, the system further comprising a color second camera disposed with an optical axis perpendicular to an optical axis of the first camera, and wherein a mirror is disposed in such a manner as to enable images of said illuminated surface to be acquired simultaneously by the first and second cameras.

11. An image acquisition system according to claim 9, wherein the illumination module further comprises two other lighting units disposed symmetrically on either side of the slot and in a manner such as to illuminate a central strip of said surface corresponding to an acquisition zone of a less sensitive one of the first and second cameras.

12. A postal sorting machine including an image acquisition system according to claim 1, the conveyor device for conveying the mailpieces being constituted by elastically deformable wheels.
